(19) United States
(12) Patent Application Publication
(10) Pub. No.: US 2015/0156116 A1
(43) Pub. Date: Jun. 4, 2015

(54) ROUTING CONTROL METHOD AND APPARATUS

(71) Applicants: INVENTEC CORPORATION, TAIPEI CITY (TW); INVENTEC (PUDONG) TECHNOLOGY CORPORATION, SHANGHAI (CN)

(72) Inventor: TE-YEN LIU, Taipei City (TW)

(73) Assignees: INVENTEC CORPORATION, TAIPEI CITY (TW); INVENTEC (PUDONG) TECHNOLOGY CORPORATION, SHANGHAI (CN)

(21) Appl. No.: 14/228,022

(22) Filed: Mar. 27, 2014

(30) Foreign Application Priority Data
Nov. 29, 2013 (CN) 201310630319.8

(51) Int. Cl. H04L 12/803; H04L 12/801

(52) U.S. Cl. CPC H04L 47/125; H04L 47/11

(57) ABSTRACT

Disclosed herein is a routing control method for balancing the load of links in a network. For each link, a load rate is periodically measured through one or more switches on the network. Based on a trigger signal generated while measuring, a packet flow passing through an overloaded link is selected. At least one substitute link through which the packet flow is to pass is determined based on the load rates, a source address, and a destination address of the packet flow. A packet handling table of at least one substitute switch on the substitute link is configured so that the packet flow passes through the substitute link.

### CROSS-REFERENCE TO RELATED APPLICATIONS

This non-provisional application claims priority under 35 U.S.C. §119(a) on Patent Application No. 201310630319.8 filed in People's Republic of China on Nov. 29, 2013, the entire contents of which are hereby incorporated by reference.

1. Technical Field

The present invention relates to routing in computer networks, particularly to a method and an apparatus for routing control on software-defined networks.

2. Background

How to balance the load of links in a network and maximize packet throughput remains an important topic in computer networking, especially as the naïve practice of ECMP (equal-cost multi-path) to allot traffic equally has become as outdated as network topologies are complicated and amount of data is multiplied.

### SUMMARY

In light of the above, the present invention discloses a routing control method and a routing control apparatus that operate independently of and do not interfere with other application software, taking advantage of the fact that routing can be centralized in software defined networks (SDNs) distinguishing the data and control planes of switches.

To perform load balancing on a plurality of links in a network, in the routing control method provided by this disclosure a load rate is periodically measured for each link through one or more switches on the network. Based on a trigger signal generated while measuring, a packet flow passing through an overloaded link is selected. At least one substitute link through which the packet flow is to pass is determined based on the load rates, a source address, and a destination address of the packet flow. A packet handling table of at least one substitute switch on the substitute link is selectively configured so as to make the packet flow passes through the substitute link. If there are a plurality of switches on the network, the substitute switch is one of them; if there is only one switch, then the substitute switch is that switch.

The routing control apparatus for performing load balancing on a plurality of links in a network comprises, as provided by this disclosure, a communication module, a processing module, and a route calculation module. The communication module measures periodically for each link a load rate through one or more switches on the network and generates a trigger signal while measuring. The processing module, coupled with the communication module, selects a packet flow passing through an overloaded link based on the trigger signal and selectively configures a packet handling table of at least one substitute switch on at least one substitute link so that the packet flow passes through the substitute link. If there are a plurality of switches on the network, the substitute switch is one of them; if there is only one switch, then the substitute switch is that switch. The route calculation module, coupled with the processing module, is what determines the substitute link based on the load rates, a source address, and a destination address of the packet flow.

In short, the routing control method and apparatus disclosed by the present invention may be implemented by a SDN controller configuring the substitute switch to redirect a packet flow on the overloaded link indicated by the trigger signal. The said steps may be repeatedly performed until the link becomes not as hard-pressed.

### BRIEF DESCRIPTION OF THE DRAWING

The present invention will become more fully understood from the detailed description given hereinbelow and the accompanying drawings which are given by way of illustration only and thus are not limitative of the present invention and wherein:

FIG. 1 is a high-level block diagram of a routing control apparatus, in accordance with one embodiment of the present invention.

FIG. 2 is a flowchart of a routing control method, in accordance with one embodiment of the present invention.

FIG. 3 is a high-level block diagram of a network, in accordance with another embodiment of the present invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

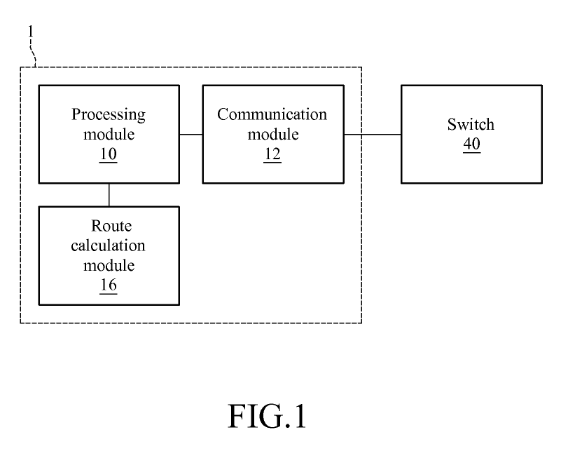

Please refer to FIG. 1. As shown in the block diagram, a routing control apparatus 1 may be a controller of a software-defined network (SDN), comprising a processing module 10, a communication module 12, and a route calculation module 16. The processing module 10 is coupled with the communication module 12 and the route calculation module 16. The SDN may be an implementation of the OpenFlow protocol, where switches open up their control planes to communicate with the controller by messages. With a network interface card (NIC) included in the communication module 12, the routing control apparatus 1 is connected through links to one or more switches on the network, for instance the switch 40.

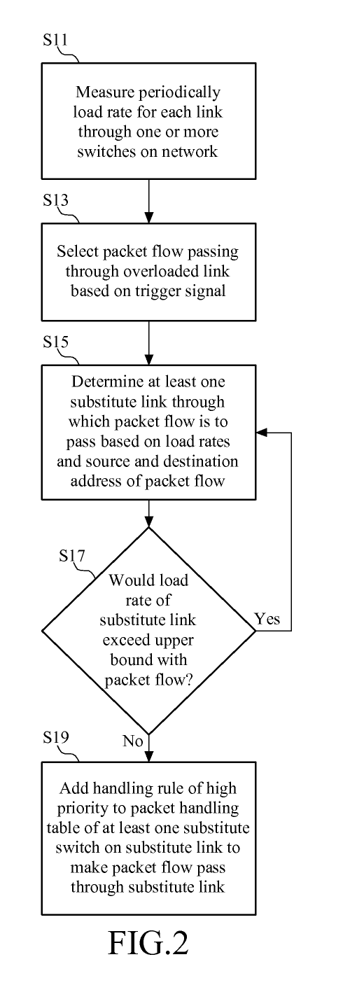

Please refer to FIG. 2 with regard to FIG. 1. As shown in the flowchart, in step S11 the communication module 12 periodically measures through the switches a load rate for each link. In practice, network measurement features like sFlow or NetFlow need to be enabled in the switches for each to report gathered information, including the load rates of visible links (e.g. the physical connections of the switch), to the monitoring communication module 12. The measurement or reporting may be real-time or of lower frequencies.

A condition may be observed in the communication module 12. When it is fulfilled, the communication module 12 generates a trigger signal indicating so. An example of the condition may be that “the load of a link exceeds 90% of its bandwidth,” with the upper bound of the load rate adjustable. In one embodiment, the communication module 12 also takes into account whether an overload is persistent, so that it only generates the trigger signal when, for example, “the load rate of the link has been over 90% for 4 seconds.”

In step S13, the processing module 10 selects one of the packet flows passing through the overloaded link. Moving any packet flow out of the link would obviously alleviate the load. In practice, the processing module 10 may obtain from a switch associated with the overloaded link a list of packet flows passing through it, and choose the packet flow with the most traffic for step S15, where the route calculation module 16 plans afresh a shortest path to deliver the chosen packet flow, based on its source and destination addresses and focusing on avoiding the overload link. The planning may employ the load rates periodically measured in step S11 as link costs. The packet flow, following the alternative path, would pass through at least one substitute link, which is different from the overloaded link, and at least one substitute switch on the substitute link.

In one embodiment, the processing module 10 determines in step S17 whether the chosen packet flow would instead overload the substitute link if referred there. Obviously if so, the communication module 12 would generate another trigger signal for the substitute link in step S13 and the route calculation module 16 would have to execute step S15 again to move the packet flow away, forming an infinite loop. In one embodiment, if the substitute link is deemed infeasible in step S17, the routing control apparatus 1 returns to step S15 to plan a new path for the packet flow. In another embodiment, the routing control apparatus 1 may return to step S13, selecting for step S15 another packet flow (e.g. the one with the second most traffic) on the original overloaded link, or give up and not exercise routing control before the general network becomes slightly less overloaded.

Upon deciding that the chosen packet flow would not overload the substitute link, the processing module 10 may configure in step S19 a packet handling table of the substitute switch in such a way that the packet flow is directed to the substitute link when received by the substitute switch. The packet handling table may be, but not limited to, the flow table defined in OpenFlow. Specifically, the processing module 10 adds a handling rule for this packet flow (identified by its source and destination addresses, for instance) in the packet handling table of the substitute switch. The rule, instituted to balance the load, should be applied with urgency and before all other rules of disparate origins. Nevertheless, the rule is also of makeshift nature. The processing module 10 may stipulate for it a time of expiry so that it no longer applies once the packet flow ends or the original overloaded link has recovered its capacity.

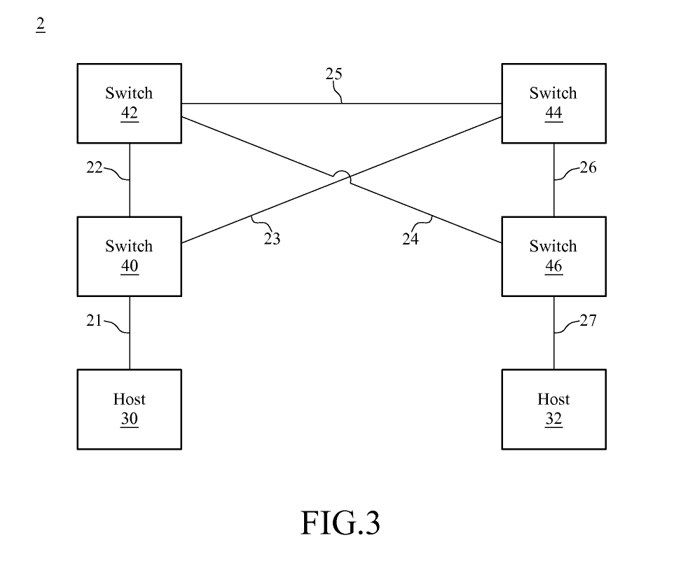

Please refer to FIG. 3 with regard to FIGS. 1 and 2. As shown in the block diagram, on a network 2 there are (terminal) hosts 30 and 32 and switches 40, 42, 44, and 46. The host 30, coupled with the switch 40 through a link 21, communicates with other hosts that may be found on the network 2 through the switch 40. The host 32 is coupled with the switch 46 through a link 27. The switches 40 and 46 are often called edge switches because they are connected to hosts, in contrast to the core switches 42 and 44 on the inside of the network 2. The switch 40 is coupled with the switch 42 through a link 22 and coupled with the switch 44 through a link 23. The switch 42 is coupled with the switch 46 through a link 24 and coupled with the switch 44 through a link 25. The switch 44 is coupled with the switch 46 through a link 26. Although not drawn in FIG. 3, conceptually the routing control apparatus 1 is coupled with the switches 40, 42, 44, and 46, while in practice it may be integrated with one of the switches on the network 2, or may be a server represented as a host.

Assume that the link 22 is overloaded in steps S11 and S13 and the processing module 10 has elected to redirect a packet flow sent to the host 32 from the host 30. The current path of the packet flow is the links 21, 22, 24, and 27, or in other words, through the switches 40, 42, and 46, in that order. Further assume that in steps S15 and S17 the routing control apparatus 1 decides that an available substitute path for the packet flow is the links 21, 23, 26, and 27, in that order, the links 23 and 26 being the substitutes. In step S19, therefore, the processing module 10 adds a rule that states “forward the packet flow from the host 30 to the host 32 on the link 23” in the packet handling table of the switch 40, and another saying “forward the packet flow from the host 30 to the host 32 on the link 26” in the switch 44, and so on.

The source and destination addresses in step S15, such as the ones identifying the hosts 30 and 32 in FIG. 3, are usually media access control (MAC) addresses. Please note that the routing control method of the present invention also has applications in the general maintenance of the network infrastructure. Specifically, in step S11 of one embodiment, switches may measure the load rates of all the links in real time, while performing parallel measurements for the internal links (e.g. the links 22 to 26) with longer intervals. The communication module 12 still generates trigger signals for the internal links upon fulfillment of conditions, though here the conditions may be slightly laxer, as with “the load rate exceeds 80%,” compared to the upper bound of 90% in the real-time network-wide measurements. The route calculation module 16 may plan substitute paths for MAC addresses on the inside of the network in step S15 based on edge switches (e.g. the switches 40 and 46) instead of the two terminal hosts of a packet flow. As an example of a substitute path, any packet flow from the switch 42 to the switch 46 (and any subsequent destination) can still be delivered through the link 25 and 26 even if the link 24 is overloaded. A handling rule for the internal links established by the processing module 10 in step S19 will not bear any relation to a host address. In one embodiment, a rule of this kind does not take precedence over those resulting from the real-time measurements and triggers, but does have a longer “shelf life” and is of higher priority than rules of origins other than the present invention.

To summarize, the routing control method and apparatus disclosed by the present invention may be implemented by a SDN controller redirecting a packet flow on an overloaded link by configuring a packet handling table on a substitute switch. The procedure may be repeatedly performed until the link becomes not as hard-pressed. In one embodiment, only when the substitute link is able to carry the packet flow without becoming overloaded is the substitute switch configured, and the added handling rule is of high priority and with an expiry time. In one embodiment, a trigger signal indicates that the load rate of the overloaded link has been exceeding an upper bound for a predefined time. In one embodiment, the general maintenance of the network infrastructure is run in parallel to the real-time measurements.

What is claimed is:

1. A routing control method for performing load balancing on a plurality of links in a network, the routing control method comprising:
measuring periodically a plurality of load rates of the links through one or more switches on the network, each of the links corresponding to one of the load rates;
selecting a packet flow passing through an overloaded link of the links based on a trigger signal generated while measuring;
determining at least one substitute link of the links to be passed through by the packet flow based on the load rates of the links, a source address of the packet flow, and a destination address of the packet flow; and
configuring selectively a packet handling table of at least one substitute switch on the substitute link to make the packet flow pass through the substitute link, the substitute switch being one of the one or more switches.

2. The routing control method of claim 1, wherein the trigger signal indicates that the load rate corresponding to the overloaded link exceeds an upper bound.

3. The routing control method of claim 2, wherein the trigger signal further indicates that the load rate corresponding to the overloaded link has been exceeding the upper bound for a predefined time.

4. The routing control method of claim 2, wherein configuring selectively the packet handling table of the substitute switch comprises:
determining whether the load rate corresponding to the substitute link would exceed the upper bound should the packet flow pass through the substitute link;
wherein a handling rule of high priority is added into the packet handling table when it is determined that the load rate corresponding to the substitute link would not exceed the upper bound, the handling rule having an expiry time.

5. The routing control method of claim 4, wherein the source address is a media access control address of one of the one or more switches, and the destination address is another media access control address of one of the one or more switches.

6. A routing control apparatus for performing load balancing on a plurality of links in a network, the routing control apparatus comprising:
a communication module for measuring periodically a plurality of load rates of the links through one or more switches on the network and for generating a trigger signal while measuring, each of the links corresponding to one of the load rates;
a processing module coupled with the communication module, for selecting a packet flow passing through an overloaded link of the links based on the trigger signal, and for configuring selectively a packet handling table of at least one substitute switch on at least one substitute link of the links to make the packet flow pass through the substitute link, the substitute switch being one of the one or more switches; and
a route calculation module couple with the processing module, for determining the substitute link through which the packet flow is to pass based on the load rates of the links, a source address of the packet flow, and a destination address of the packet flow.

7. The routing control apparatus of claim 6, wherein the trigger signal indicates that the load rate corresponding to the overloaded link exceeds an upper bound.

8. The routing control apparatus of claim 7, wherein the trigger signal further indicates that the load rate corresponding to the overloaded link has been exceeding the upper bound for a predefined time.

9. The routing control apparatus of claim 7, wherein when the processing module configures selectively the packet handling table, the processing module determines whether the load rate corresponding to the substitute link would exceed the upper bound should the packet flow pass through the substitute link, and when it is determined that the load rate corresponding to the substitute link would not exceed the upper bound, the processing module adds a handling rule of high priority into the packet handling table, the handling rule having an expiry time.

10. The routing control apparatus of claim 9, wherein the source address is a media access control address of one of the one or more switches, and the destination address is another media access control address of one of the one or more switches.
